(19) United States
(12) Patent Application Publication
(10) Pub. No.: US 2005/0169698 A1
(43) Pub. Date: Aug. 4, 2005

(54) Bicycle seat post

(76) Inventors: Christopher S. Conroy, Evergreen, CO (US); Steven W. Hoogendoorn, Evergreen, CO (US)

Correspondence Address: DORSEY & WHITNEY, LLP;INTELLECTUAL PROPERTY DEPARTMENT, 370 SEVENTEENTH STREET, SUITE 4700, DENVER, CO, 80202-5647, US

(21) Appl. No.: 10/771,580

(22) Filed: Feb. 3, 2004

(51) Int. Cl. F16B 7/10

(52) U.S. Cl. 403/109.1

(57) ABSTRACT

The present invention provides a seat post for a bicycle that is of unitary construction and provides for a stress relief area on the post to reduce the possibility of damage caused by a clamping mechanism on a seat tube of a bicycle frame. The seat post may be configured to include a member defined by a tubular region integral with a head region. The tubular region may also include at least one region with a circular outer circumference, and a clamp region having a circumference defined by a circular surface and a stress relief surface. The stress relief surface may also have various contours. For example, the stress relief are may be flat or arcuate in shape.

### BACKGROUND OF THE INVENTION

a. Field of the Invention

This invention is generally related to bicycles, and more particularly, to seat posts for bicycles.

b. Background Art

Seat posts are used to connect a bicycle seat or saddle with the frame of a bicycle. Some seat posts currently available on the market are constructed from at least two separate pieces, such as a head piece connected to a post. The post is configured to have one end inserted into and telescopically engage a seat tube on a bicycle frame. The opposite end of the seat post is configured to connect with the separate head piece. The separate head piece is configured to accommodate a mechanism to provide for connection with the bicycle seat or saddle. Once the seat post is inserted into the seat tube of the bicycle frame to the desired depth, a clamping mechanism on the seat tube is used to exert pressure on the outer surface of the seat post to frictionally engage and clamp to hold the seat post in position relative to the seat tube.

Seat posts and head pieces are usually constructed from high strength materials so the rider of the bicycle is safely and reliably supported. However, it is frequently desirable to reduce the total weight of the bicycle. One way to accomplish this goal is to manufacture various parts of the bicycle, such as the seat post, from high-strength, light weight materials, such as carbon or fiberglass composites. Although these materials provide the necessary strength to allow the seat post to support a rider of the bicycle, the seat posts may be susceptible to damage, such as cracking, caused possibly from the clamping device exerting pressure on the outer surface of the post. Some manufacturers have addressed this problem by utilizing various alternative clamp designs and/or post designs.

The present invention addresses the shortcomings of the current seat post designs. In addition, seat posts made in accordance with the present invention generally weigh less than the multi-piece seat post designs made from similar material currently available on the market.

### BRIEF SUMMARY OF THE INVENTION

The present invention utilizes improvements in the availability of light weight high-strength materials to construct a seat post as a single member having an integral head and post, while at the same time providing for stress relief in the post to reduce the possibility of damage caused by a clamping device used to hold the seat post securely in the seat tube.

In one embodiment of the present invention, a seat post for a bicycle includes a member defined by a tubular region integral with a head region. A length of the tubular region includes at least one region with a circular outer circumference, and a clamp region having a circumference defined by a circular surface and a stress relief surface.

In another embodiment of the present invention, a seat post for a bicycle includes a member defined by a single shell including a tubular region integral with a hollow head region, wherein the tubular region includes a first region, a second region, and a third region, wherein the second region separates the first region and the third region. The head region transitions to the tubular region at the first region, and the first region and the third region each have a circular outer circumference symmetrical about a first longitudinal axis of the tubular region. The second region has a circumference defined by a circular surface and a stress relief surface. A second longitudinal axis of the head region intersects with the first longitudinal axis.

In a further embodiment of the instant invention, a seat post for a bicycle includes a member defined by a single shell including a tubular region integral with a hollow head region, wherein a length of the tubular region includes at least one region with a circular outer circumference symmetrical about a first longitudinal axis, and a clamp region having a circumference defined by a circular surface and a stress relief surface, and wherein the head region is symmetrical about a second longitudinal axis, and the second longitudinal axis intersects with the first longitudinal axis.

The features, utilities, and advantages of various embodiments of the invention will be apparent from the following more particular description of embodiments of the invention as illustrated in the accompanying drawings and defined in the appended claims.

### BRIEF DESCRIPTION OF THE DRAWINGS

FIG. 1 is partial side view of a seat post inserted into a seat tube.

FIG. 2 is a top cross-sectional view of a clamping mechanism, seat post, and seat tube taken along line 2-2 of FIG. 1.

FIG. 3 is an isometric view of a seat post according to an embodiment of the present invention.

FIG. 4 is a front view of the seat post depicted in FIG. 3.

FIG. 5A is a left side cross-sectional view of the seat post taken along line 5-5 of FIG. 4.

FIG. 5B is a detailed view of a head region of the seat post depicted in FIG. 5A.

FIG. 6A is a top cross-sectional view of an embodiment of the seat post having a flat stress relief surface taken along line 6-6 of FIG. 4.

FIG. 6B is a top cross-sectional view of an embodiment of the seat post having a convex stress relief surface taken along line 6-6 of FIG. 4.

FIG. 6C is a top cross-sectional view of an embodiment of the seat post having a concave stress relief surface taken along line 6-6 of FIG. 4.

FIG. 7 is a top cross-sectional view of a head region of the seat post taken along line 7-7 of FIG. 4.

FIG. 8 is an isometric view of a seat post according to an embodiment of the present invention having a head region offset from a tubular region.

FIG. 9 is a right side view of the seat post depicted in FIG. 8.

### DETAILED DESCRIPTION OF THE INVENTION

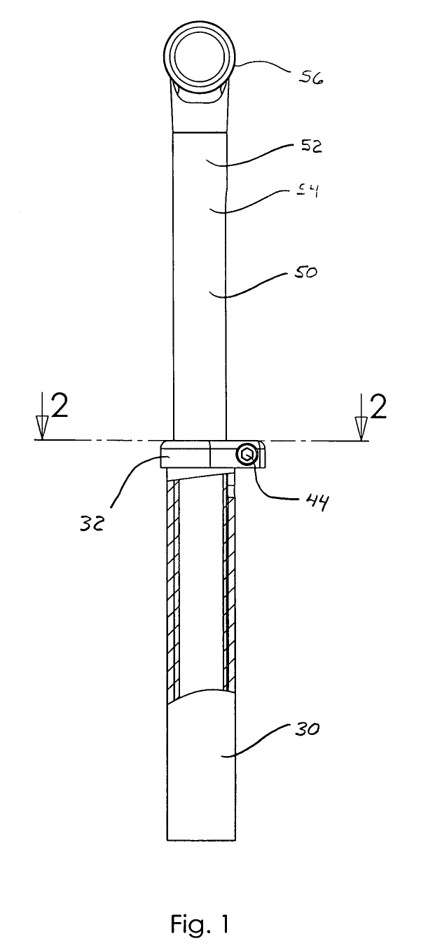

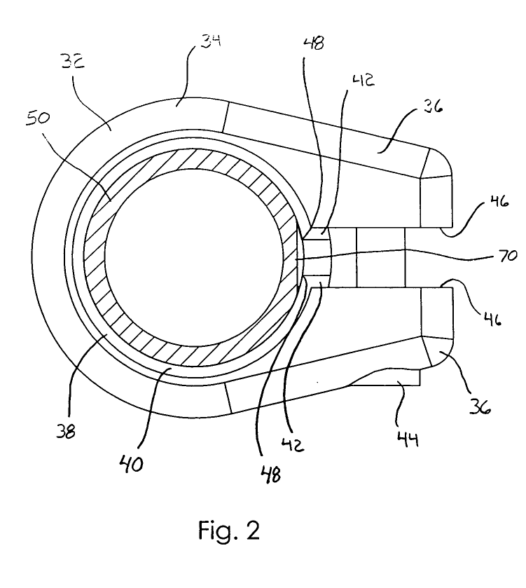

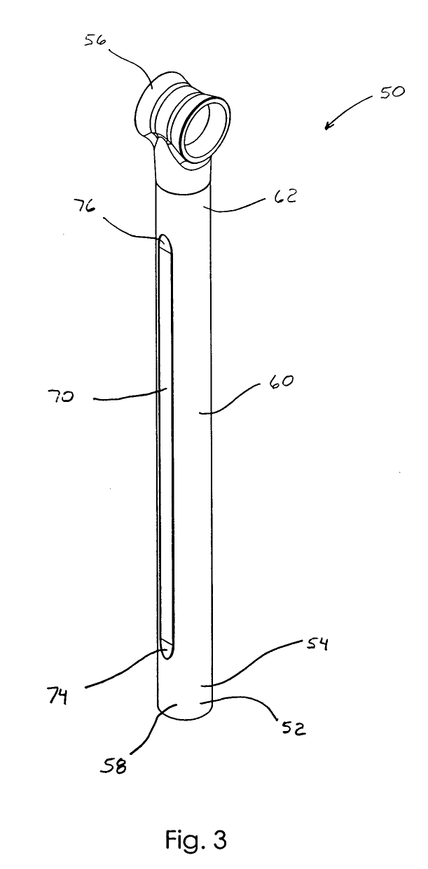

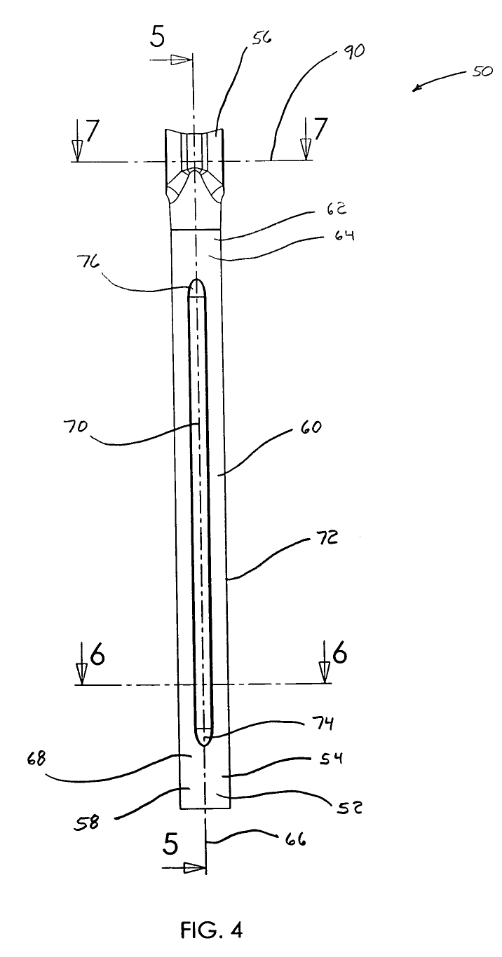

The present invention provides a seat post 50 for a bicycle. As shown in FIG. 1, the seat post 50 connects with a seat tube 30 on a bicycle frame and is used to support a bicycle seat or saddle, upon which a rider of the bicycle is supported. One embodiment of the seat post 50 according to the present invention includes a member 52 having a tubular region 54 and a head region 56. A clamping mechanism 32, as shown in FIGS. 1 and 2, engages the tubular region 54 of the seat post 50 to hold the seat post in position relative to the bicycle frame. As shown in FIGS. 3 and 4, the tubular region may be cylindrically-shaped, hollow, and may be defined by a lower region 58, a middle region 60, and an upper region 62. As discussed in more detail below, the saddle connects with the head region.

As shown in FIGS. 1 and 2, the clamping mechanism 32 on the seat tube 30 of the bicycle frame can include a C-shaped outer clasp 34 having a pair of outer extensions 36; a clamp ring 38 defined by a ring portion 40 connected with a pair of inner extensions 42; and a bolt 44. When connecting the seat post with the bicycle frame, the lower region 58 and a portion of the middle region 60 of the seat post 50 are inserted into the seat tube 30 on the bicycle frame to a desired depth so the clamping mechanism 32 can engage the middle region. Once the seat post is inserted into the seat tube to the desired depth, the bolt 44 on the clamping mechanism 32 is tightened, which forces the outer extensions 36 of the C-shaped outer clasp 34 toward each other. Forcing the outer extensions 36 toward each other causes inner surfaces 46 of the outer extensions to press against the inner extensions 42 of the clamp ring 38, which in turn causes the ring portion 40 to grip and hold the seat post 50 in a fixed position relative to the seat tube 30. Clamping mechanisms on bicycle seat tubes are known in the art, and it is to be appreciated that the present invention is not limited to use with the clamping mechanism depicted and described herein.

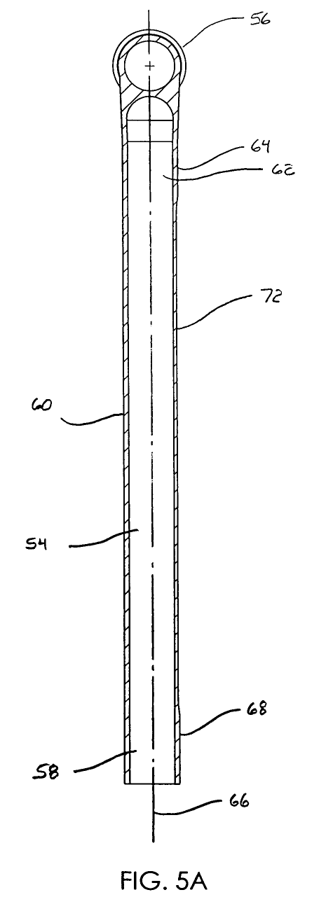

As shown in FIGS. 4 and 5A, an outer circumference of the upper region of the seat post is defined by a first circular outer surface 64 that is symmetrical about a longitudinal axis 66 of the tubular region 54. An outer circumference of the lower region 58 is defined by a second circular outer surface 68 that is also symmetrical about the longitudinal axis 66 of the tubular region 54. An outer circumference of the middle region 60 is defined by a stress relief surface 70 and a third circular outer surface 72. The third circular outer surface 72 extends circumferentially for less than 360° around the longitudinal axis 66 of the tubular region 54.

Referring now to FIG. 2, when the seat post 50 is inserted into the seat tube 30, the stress relief surface 70 provides a portion of the tubular region 54 that is not contacted by clamp ring 38. In particular, inner edges 48 defined by the intersection of the ring portion 40 and the inner extensions 42 of the clamp ring 38 do not contact the tubular region 54 of the seat post 50. As such, the likelihood of damage to the seat post that could otherwise be caused by forcing the inner edges 48 of the clamp ring against the seat post is reduced when tightening the bolt 44 of the clamping mechanism 32.

It is to be appreciated that the stress relief surface 70 can also be of various lengths and can be located in various radial and/or longitudinal locations along the tubular region 54. For example, in one embodiment of the present invention, the stress relief surface extends the entire length of the tubular region. In another embodiment, the stress relief surface extends from a bottom end of the tubular region upwardly toward the head region for less than the entire length of the tubular region. In yet another embodiment of the present invention, the inner edges of the clamp ring can be chamfered to eliminate the stress point, and thus the post could be provided with no stress relief surface.

As shown in FIGS. 3 and 4, the tubular region 54 can also include a first transition region 74 and a second transition region 76. In the first transition region 74, the shape of the outer circumference of the middle region 60 smoothly transitions to the shape of the outer circumference of the lower region 58. Similarly, in the second transition region 76, the shape of the outer circumference of the middle region 60 smoothly transitions to the shape of the outer circumference of the upper region 62. Other embodiments of the present invention may not have two transition regions or may not include any transition regions.

The seat post according to the present invention can be constructed from various types of materials. For example, one embodiment of the seat post is constructed from a single shell made from a carbon composite material. As well as being strong, the carbon composite material provides the advantage of having less density than other materials with comparable strength properties, which helps to reduce the total weight of the bicycle. In another embodiment of the invention, the seat post is constructed from aluminum. Depending upon the particular configuration and material used, the outer diameter and the wall thickness of the tubular region can vary. For example, one embodiment of the present invention utilizes an outer diameter of 27.2 mm in the lower region and/or the upper region. In addition, the minimum and maximum insertion depths of the seat post into the seat tube of the bicycle can vary. For example, one embodiment of the present invention includes a 3″ minimum insertion depth and a 9⅝″ maximum insertion depth.

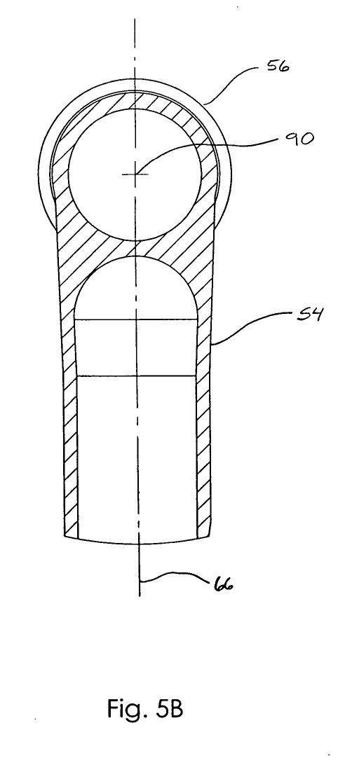

As shown in FIGS. 3, 4, and 5A, the stress relief surface 70 can span the entire length of the middle region 60 and can utilize various contours. For example, in one embodiment of the invention shown in FIG. 6A, the stress relief surface 70 is flat. The width of the stress relief surface can also vary depending on the particular application. For example, in one embodiment of the invention, the width of the stress relief surface is 8.5 mm.

In another embodiment of the invention shown in FIG. 6B, the stress relief surface 70 is a convex surface defined by a first radius 78. The first radius 78 is larger than a second radius 80 defining the first circular outer surface 64, the second circular outer surface 68, and/or the third circular outer surface 72. Depending upon the application, various sizes of the first radius can be used. For example, the first radius can be 30 mm, 40 mm, and 50 mm in some embodiments of the present invention. In yet another embodiment of the invention shown in FIG. 6C, the stress relief surface 70 is a concave surface. It should also be appreciated that other embodiments of the present invention can utilize a stress relief surface that can be arcuate or some other type of shape providing the requisite stress relief function than what is depicted herein.

At the upper region 62, the tubular region 54 transitions to the integral head region 56. It is to be appreciated that the head region 56 can be configured in different ways to accommodate various types of saddles and/or seat securing mechanisms utilized to secure the saddle to the seat post. For example, as shown in FIGS. 3, 5B, and 7, the head region 56 can be configured to accommodate a seat securing mechanism similar to the one disclosed in pending patent application Ser. No. 10/116,697, filed on Apr. 3, 2002, which is hereby incorporated by reference in its entirety as if fully disclosed herein.

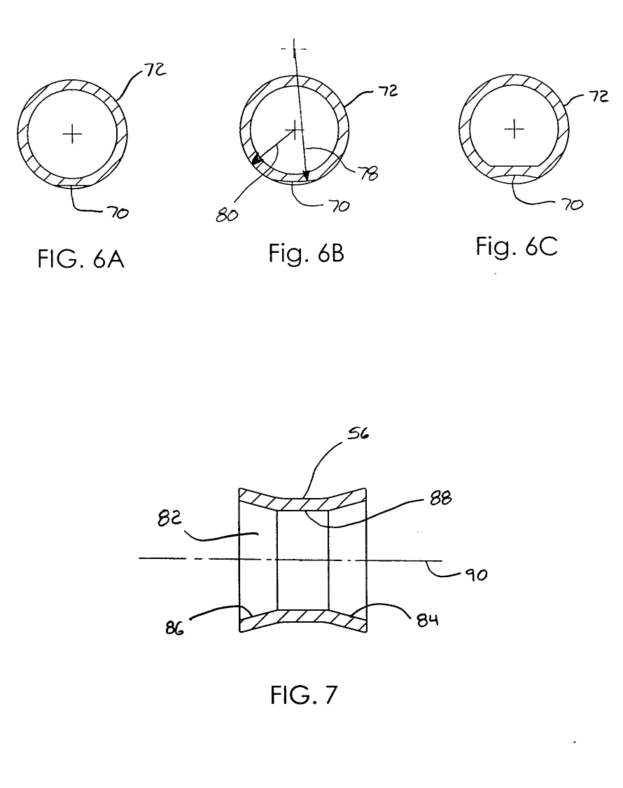

As shown in FIGS. 3, 5A, 5B, and 7, the head region 56 is generally cylindrical in shape, is transversely oriented with respect to the tubular region, and includes a hollow inner region 82. The hollow inner region 82 is defined by a first tapered portion 84 and a second tapered portion 86 separated by a middle head portion 88. The first tapered portion 84 and the second tapered portion 86 extend from the middle portion 88 outwardly along a longitudinal axis 90 of the hollow inner region 82 while also expanding radially from the longitudinal axis 90, as shown in FIG. 7. Depending on the particular configuration, a sheath or strengthening insert may be installed inside the hollow inner region to provide additional strength to the head region and/or provide an interface with the seat securing mechanism. As shown in FIG. 4, the head region 56 can be centered on the tubular region 54 such that the longitudinal axis 90 of the head region and the longitudinal axis 90 of the tubular region intersect.

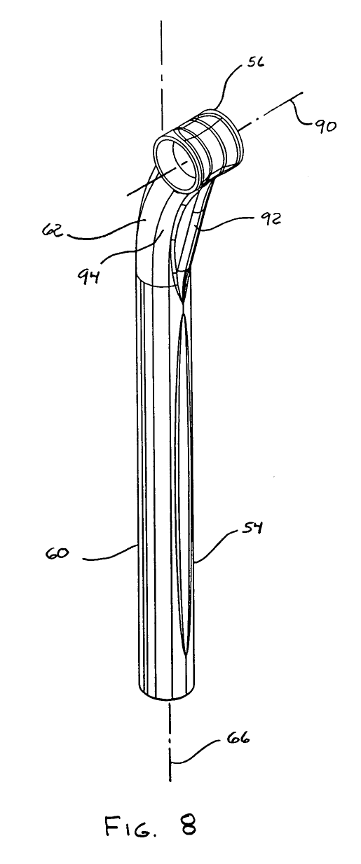

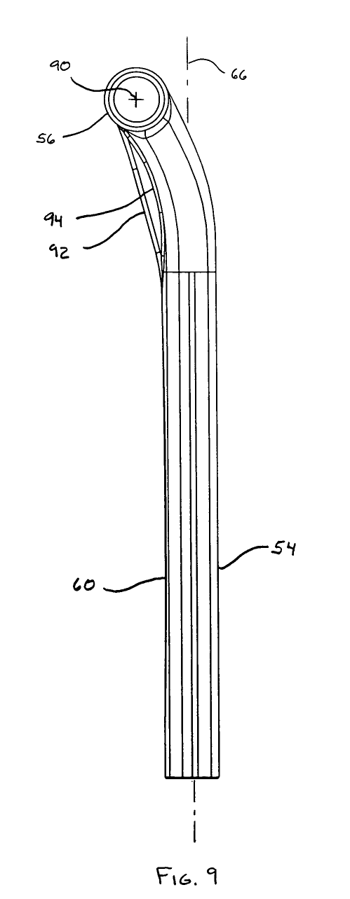

It is to be appreciated that the head region 56 need not be centered on the tubular region 54. For example, the head region can be offset rearwardly or forwardly from the tubular region. As shown in FIGS. 8 and 9, in one embodiment of the invention, the upper region 62 of the tubular region 54 can curve forwardly from the middle region 60 until transitioning to the head region 56. As such, the longitudinal axis 90 of the head region of the seat post depicted in FIGS. 8 and 9 does not intersect the longitudinal axis 66 of the tubular region, but instead, the longitudinal axis 66 of the tubular region extends behind the head region. In a configuration where the head region is offset rearwardly from the tubular region, the longitudinal axis 66 of the tubular region extends forwardly of the head region. In addition, the seat post can include a bracket 92 along a concave surface 94 of the upper region 62 to help support the head region 56. It should also be noted that a curve-shaped upper region is not required for an embodiment having a head region offset from the tubular region. For example, the upper region in some embodiments can be a sharp corner defined by a right angle.

Although various embodiments of this invention have been described above with a certain degree of particularity or with reference to one or more individual embodiments, those skilled in the art could make numerous alterations to those disclosed embodiments without departing from the spirit or scope of this invention. It is intended that all matter contained in the above description and shown in the accompanying drawings shall be interpreted as illustrative only of particular embodiments, and not limiting. Changes in detail or structure may be made without departing from the basic elements of the invention as defined in the following claims.

1. A seat post for a bicycle comprising:
a member defined by a tubular region integral with a head region; and
wherein a length of said tubular region includes at least one region with a circular outer circumference, and a clamp region having a circumference defined by a circular surface and a stress relief surface.

2. The seat post of claim 1, wherein said member is a shell constructed from a carbon composite material.

3. The seat post of claim 1, wherein said at least one region includes a first region and a second region separated by said clamp region.

4. The seat post of claim 3, wherein said head region transitions to said tubular region at said second region.

5. The seat post of claim 1, wherein said stress relief surface is flat.

6. The seat post of claim 1, wherein said stress relief surface has an arcuate shape defined by a first radius that is larger than a second radius defining said circular surface.

7. The seat post of claim 1, wherein said stress relief surface extends linearly along the length of said clamp region.

8. The seat post of claim 1, wherein said head region includes a hollow inner region, and wherein a first center longitudinal axis of said head region intersects with a second center longitudinal axis of said tubular region.

9. The seat post of claim 8, wherein said hollow inner region is defined by a first tapered portion and a second tapered portion separated by a middle portion, and wherein said first tapered portion and said second tapered portion extend outwardly along said first longitudinal axis while expanding radially from said first longitudinal axis.

10. The seat post of claim 1, wherein said at least one region curves forwardly from a longitudinal axis of said tubular region before transitioning to said to head region.

11. A seat post for a bicycle comprising:
a member defined by a single shell including a tubular region integral with a hollow head region;
wherein said tubular region includes a first region, a second region, and a third region, wherein the second region separates said first region and said third region;
wherein said head region transitions to said tubular region at said first region;
wherein said first region and said third region each have a circular outer circumference symmetrical about a first longitudinal axis of said tubular region;
wherein said second region has a circumference defined by a circular surface and a stress relief surface; and
wherein a second longitudinal axis of said head region intersects with said first longitudinal axis.

12. The seat post of claim 11, wherein said stress relief surface extends linearly along the entire length of said second region.

13. The seat post of claim 11, wherein said stress relief surface is flat.

14. The seat post of claim 11, wherein said stress relief surface has an arcuate shape.

15. The seat post of claim 11, wherein said member is constructed from a carbon composite material.

16. The seat post of claim 11, wherein said head region includes a hollow inner region defined by a first tapered portion and a second tapered portion separated by a middle portion, and wherein said first tapered portion and said second tapered portion extend outwardly along said second longitudinal axis while expanding radially from said second longitudinal axis.

17. A seat post for a bicycle comprising:
a member defined by a single shell including a tubular region integral with a hollow head region;
wherein a length of said tubular region includes at least one region with a circular outer circumference symmetrical about a first longitudinal axis, and a clamp region having a circumference defined by a circular surface and a stress relief surface; and
wherein said head region is symmetrical about a second longitudinal axis, and said second longitudinal axis intersects with said first longitudinal axis.

18. The seat post of claim 17, wherein said head region includes a hollow inner region defined by a first tapered portion and a second tapered portion separated by a middle portion, and wherein said first tapered portion and said second tapered portion extend outwardly along said second longitudinal axis while expanding radially from said second longitudinal axis.

19. The seat post of claim 17, wherein said stress relief surface is flat.

20. The seat post of claim 17, wherein said stress relief surface has an arcuate shape defined by a first radius that is larger than a second radius defining said circular surface.

21. The seat post of claim 17, wherein said member is constructed from a carbon composite material.
